(19) United States
(12) Patent Application Publication
(10) Pub. No.: US 2019/0139108 A1
(43) Pub. Date: May 9, 2019

(54) INFORMATION PROCESSING APPARATUS AND DISPLAY METHOD

(71) Applicant: Bank Invoice Corporation, Tokyo (JP)

(72) Inventor: Taro Teshima, Tokyo (JP)

(21) Appl. No.: 16/236,273

(22) Filed: Dec. 28, 2018

Related U.S. Application Data
(63) Continuation of application No. PCT/JP2017/023125, filed on Jun. 23, 2017.

(30) Foreign Application Priority Data
Jun. 28, 2016 (JP) 2016-128168

(51) Int. Cl. G06Q 30/04; G06K 9/00

(52) U.S. Cl. CPC G06Q 30/04; G06K 9/00442

(57) ABSTRACT

An invoice management apparatus includes an invoice data storage unit for storing therein invoice data, a format storage unit for storing therein a common format in which display items are fixed and an original format in which the display items are changeable according to user requests, and a data processing unit for displaying invoice data in the common format and the invoice data in the original format in response to a request for displaying the invoice data.

### CROSS-REFERENCE TO RELATED APPLICATION

This application is a continuation application of International Application PCT/JP2017/023125 filed on Jun. 23, 2017, designating the U.S. and claiming priority from Japanese Patent Application No. 2016-128168 filed on Jun. 28, 2016. The entire contents of both foregoing applications are incorporated herein by reference.

### FIELD

The embodiment discussed herein relates to an information processing apparatus and a display method.

### BACKGROUND

There is known a technique for achieving unified management for viewing of business documents (for example, invoices and others) of an entire company or an entire corporate group and information thereof.

For example, there is known an information processing apparatus that has a first storage unit that stores therein user information associating user identification information identifying a user and at least one piece of unique information with each user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

Please see, for example, International Publication Pamphlet No. WO 2015/049948.

Consider, by way of example, the case where business documents are invoices. Since different companies have different formats for invoices to be issued, there is a great demand of customizing an invoice screen. On the other hand, it is convenient to use a common format for invoices in system development.

### SUMMARY

To achieve the above object, there is provided an information processing apparatus including: a storage unit configured to store therein, upon receipt of document data relating to a business document sent from a terminal device to a specific recipient over a network, the received document data in association with identification information of the recipient and identification information of an issuer of the document data; a storage unit configured to store therein a first format in which display items are fixed and a second format in which the display items are changeable according to a user request; a processing unit configured to create, based on first document data created using the first format by the issuer, second document data using the second format, the second document data having identical contents to the first document data and having desired display items; and a display unit configured to display the first document data created using the first format and the second document data created using the second format in response to a request for displaying the document data from the recipient.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to one embodiment.

FIG. 2 is a view for explaining an example of a screen that is displayed on a terminal device after a login.

FIG. 3 illustrates a hardware configuration of an invoice management apparatus according to the embodiment.

FIG. 4 is a block diagram illustrating functions of the invoice management apparatus according to the embodiment.

FIG. 5 is a view for explaining an example of invoice data.

FIG. 6 is a view for explaining information to be displayed in a summary display area.

FIGS. 7A and 7B are views for explaining information to be displayed in the summary display area.

FIG. 8 is a view for explaining how to process returned invoice data.

FIG. 9 is a view for explaining a management screen for creating a new invoice.

FIG. 10 is a view for explaining the management screen for creating the new invoice.

FIG. 11 illustrates an invoice to be displayed in an original display area.

FIG. 12 illustrates a management screen to be displayed on a terminal device operated by an accounting personnel of a bill-to party.

### DESCRIPTION OF EMBODIMENTS

Hereinafter, an invoice management system according to one embodiment will be described in detail with reference to the accompanying drawings.

### Embodiment

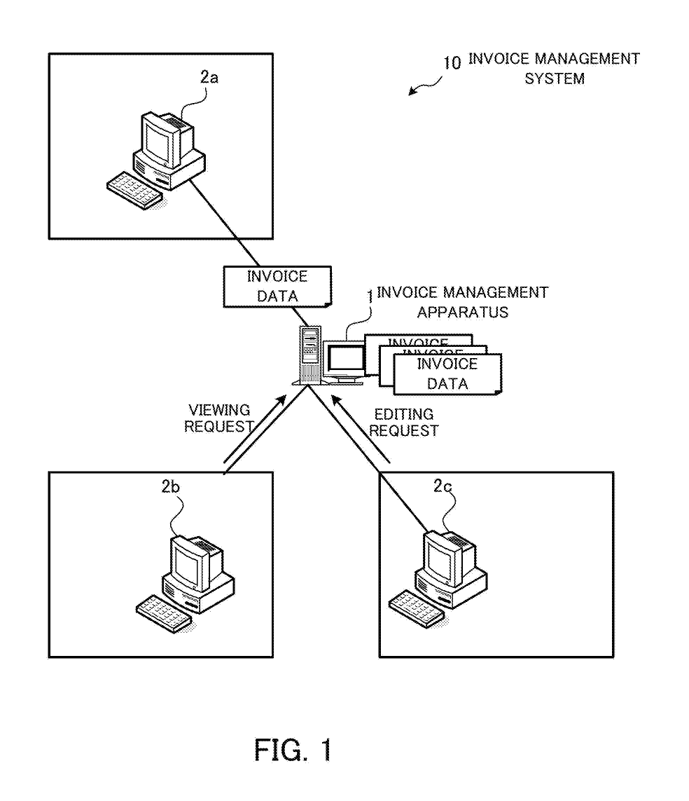

FIG. 1 illustrates an invoice management system according to one embodiment.

In the invoice management system 10 of the embodiment, an invoice management apparatus (information processing apparatus) 1 is connected to terminal devices 2a, 2b, and 2c over the Internet or a dedicated network.

The terminal devices 2a, 2b, and 2c are placed at accounting departments of different companies. For example, the terminal device 2a is placed at a company A, the terminal device 2b is placed at a company B, and the terminal device 2c is placed at a company C. Examples of the terminal devices 2a, 2b, and 2c include desktop personnel computers, laptop personnel computers, tablet terminals, and smartphones.

A web program is installed in the invoice management apparatus 1 and the terminal devices 2a, 2b, and 2c. The terminal devices 2a, 2b, and 2c communicate invoice data on invoices with the invoice management apparatus 1 through Web browsers. In this connection, the embodiment explains communication of invoice data, but invoices are an example of business documents and the embodiment is not limited thereto. Other examples of business documents include estimate forms, order forms, electronic medical charts, and prescriptions.

Hereinafter, it is assumed that the invoice management system 10 is used by the individual accounting persons of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel of the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting persons are able to operate their terminal devices 2a, 2b, and 2c to process invoice data, which is a digitized version of original invoices, via the invoice management apparatus 1. The processing of invoice data include creation, sending, receipt, viewing, editing, and others.

For example, when the accounting personnel of the company A issues an invoice to the company B, the accounting personnel of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, and 2c. Rather, all invoice data created by the terminal devices 2a, 2b, and 2c and sent to bill-to parties is held by the invoice management apparatus 1. The invoice data is treated like shared data. The invoice management apparatus 1 gives viewing and editing authorities for the invoice data to the terminal devices 2a, 2b, and 2c according to necessity.

The above approach makes it possible to digitize and process original invoices electronically, which leads to saving labor for management and storage of paper- or PDF-based invoices.

As described above, invoice data is not communicated directly between the terminal devices 2a, 2b, and 2c. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c.

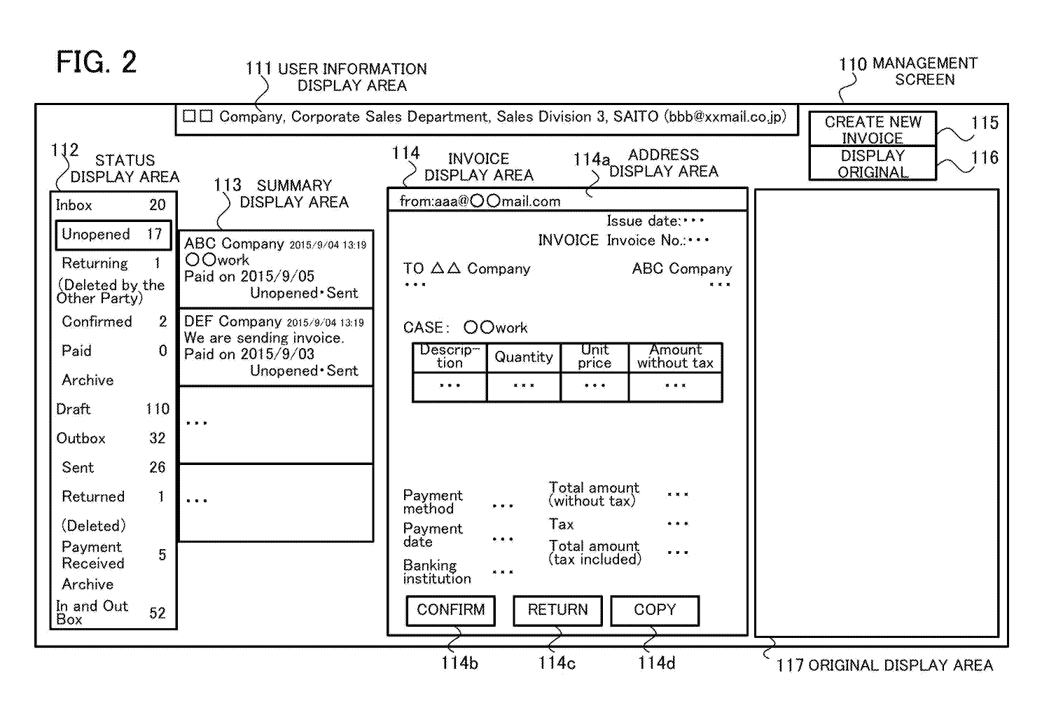

FIG. 2 is a view for explaining an example of a screen that is displayed on a terminal device after a login.

The management screen 110 illustrated in FIG. 2 is an example of a screen to be displayed on the terminal device 2a.

As illustrated in FIG. 2, an accounting personnel is able to create, issue, view, and edit invoice data, like he/she uses mail software.

By the way, in the above-described example, the accounting personnel of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

Now, the disclosed invoice management system will be described more concretely.

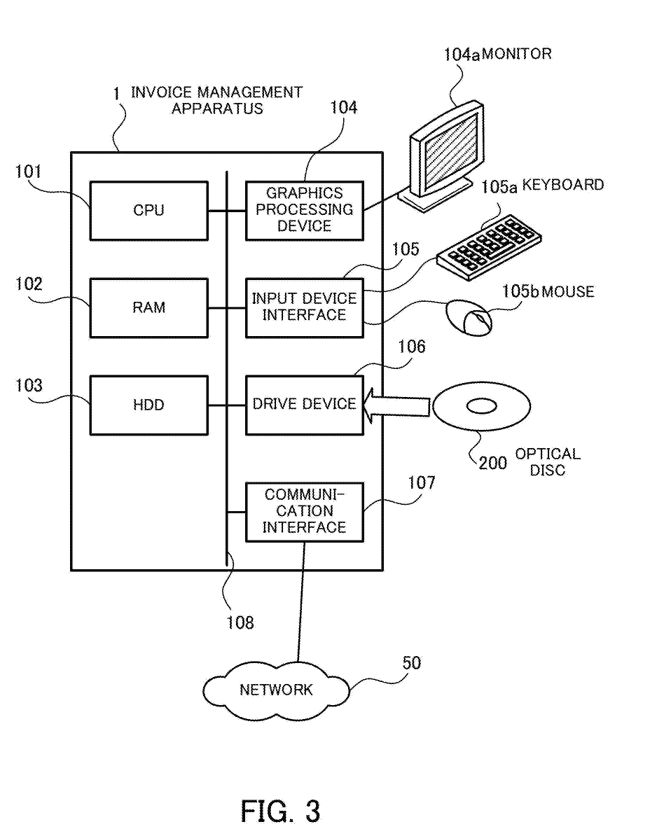

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of OS (operating system) programs and application programs that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. The OS programs, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on the optical disc 200 may be read with laser light or the like. Examples of the optical disc 200 include Blu-ray (registered trademark), DVD (digital versatile disc), DVD-RAM, CD-ROM (compact disc read only memory), CD-R (recordable), and CD-RW (rewritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 has the following functions.

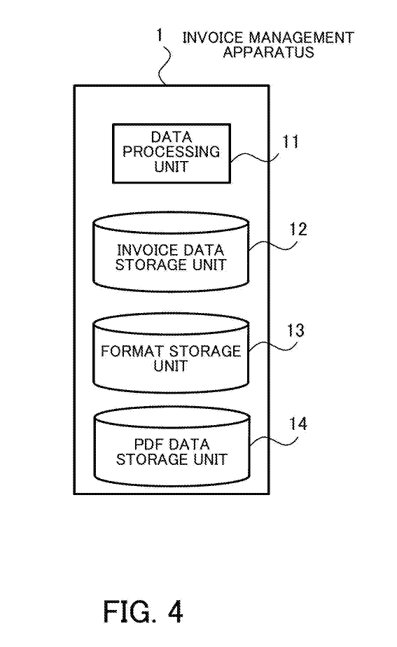

FIG. 4 is a block diagram illustrating functions of the invoice management apparatus according to the present embodiment.

The invoice management apparatus 1 has a data processing unit 11, an invoice data storage unit 12, a format storage unit 13, and a pdf data storage unit 14.

The data processing unit 11 displays the management screen 110 illustrated in FIG. 2 on the terminal device 2a or the like in accordance with accounting personnel's operations. The data processing unit 11 performs appropriate processing according to operations made to invoice data on the management screen 110. For example, the data processing unit 11 classifies and stores invoice data received by the invoice management apparatus 1, external communications and memos made by an accounting personnel, and others in appropriate storage units.

The invoice data storage unit 12 stores therein invoice data received by the invoice management apparatus 1, by accounting personnel (more specifically, by mail address of accounting personnel). The invoice data received by the invoice management apparatus 1 includes invoice data sent from accounting persons of billing parties to accounting persons of bill-to parties and invoice data drafted by the accounting persons (issuers) of the billing parties.

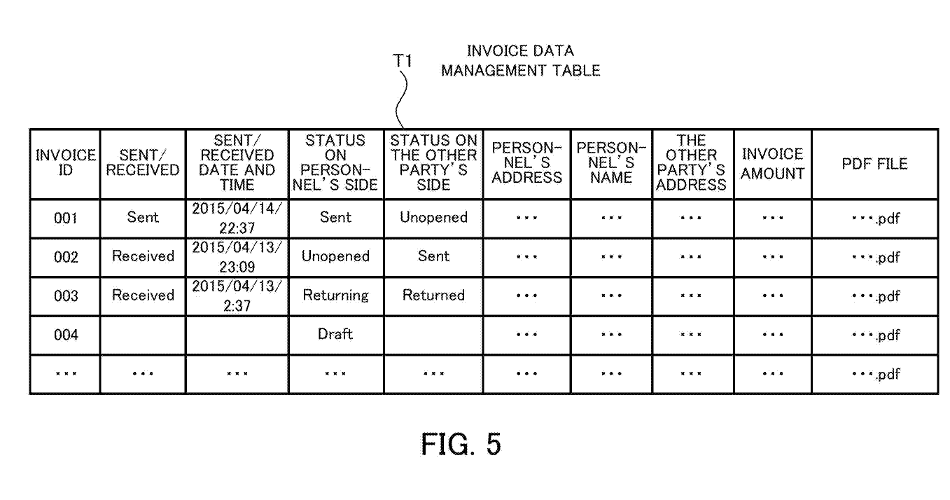

FIG. 5 is a view for explaining an example of invoice data.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's Address, Personnel's Name, The Other Party's Address, Invoice Amount, and PDF File. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Address column contains the mail address of the accounting personnel.

The Personnel's Name column contains the department to which the accounting personal belongs and the name of the accounting personnel.

The Other Party's Address column contains the mail address of the accounting personnel of the other party that communicates the invoice data.

The Invoice Amount column indicates the invoice amount of the invoice.

The PDF File column contains the file name of a pdf file of the invoice data created using an original format (will be described later). In this connection, the PDF File column may contain a unique ID identifying the file.

In addition to the above-described information, the invoice data management table contains information indicated in general invoices, such as the company name of the accounting personnel, the company name of the accounting personnel of the other party that communicates the invoice data, the postal codes and addresses of both companies, departments, account number, and others.

The format storage unit 13 stores therein a common format (first format) for displaying invoices on the management screen 110 and an original format (second format) for invoices uniquely prepared by each company.

The common format is a format for invoices to be displayed in an invoice display area 114. Display items (what and where to display) for the common format are fixed, and accounting persons are not allowed to modify the contents of the common format.

The original format is a format for invoices to be displayed in an original display area 117. The display items for the original format are not fixed, and accounting persons are able to modify the contents of the format on a format customize screen (not illustrated).

An original format created on this format customize screen is stored in association with the mail address of the accounting personnel in the format storage unit 13. In this connection, one accounting personnel is able to create a plurality of original formats. In this case, each original format is stored in association with the mail address of the accounting personnel in the format storage unit 13.

When the accounting personnel has selected a Display Original button, to be described later, the data processing unit 11 retrieves the corresponding original format from the format storage unit 13 and displays the original format on the management screen 110.

The pdf data storage unit 14 stores therein invoice data created using an original format, in pdf format. In this connection, the file format is not limited to the pdf format.

(Management Screen)

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, an invoice display area 114, a Create New Invoice button 115, a Display Original button 116, and an original display area 117.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel has selected the Inbox folder, the data processing unit 11 refers to the invoice data management table T1. Then, the data processing unit 11 displays, in the summary display area 113, the summary of invoice data that has “Received” in the Sent/Received column, among invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the billing party among the invoice data placed in the Inbox folder.

The “Deleted by the Other Party” status is given by the data processing unit 11 to invoice data that has been received, returned by the accounting personnel to the accounting personnel of the billing party, and then deleted by the accounting personnel of the billing party, among the invoice data placed in the Inbox folder.

The “Confirmed” status is given by the data processing unit 11 to invoice data which the accounting personnel has viewed and for which the accounting personnel has selected a Confirm button (will be described later), among the invoice data placed in the Inbox folder.

The “Paid” status is given by the data processing unit 11 to invoice data for which the accounting personnel has made payment (pay) and then selected a Paid button displayed in the invoice display area 114, among the invoice data placed in the Inbox folder.

The accounting personnel compiles the invoice data in the Paid status to confirm the details of the payment (payment statement).

The “Archive” status is given by the data processing unit 11 to invoice data which the account personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the content of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel has selected the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel has selected the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process (correct or delete) the invoice data returned from the bill-to party.

The “Deleted” status is given by the data processing unit 11 to invoice data that has been deleted by the accounting personnel of the billing party, among the invoice data returned from the accounting personnel of the bill-to party.

The “Payment Received” status is given by the data processing unit 11 to invoice data for which the accounting personnel of the billing party has confirmed payment and selected a Payment Received button (will be described later), among the invoice data placed in the Outbox folder.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the content of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a billing party, a case name, a payment date and time, a status on the sender side, and a status on the recipient side.

The same statuses are displayed on the management screens of both the accounting personnel who has sent invoice data and the accounting personnel who has received the invoice data.

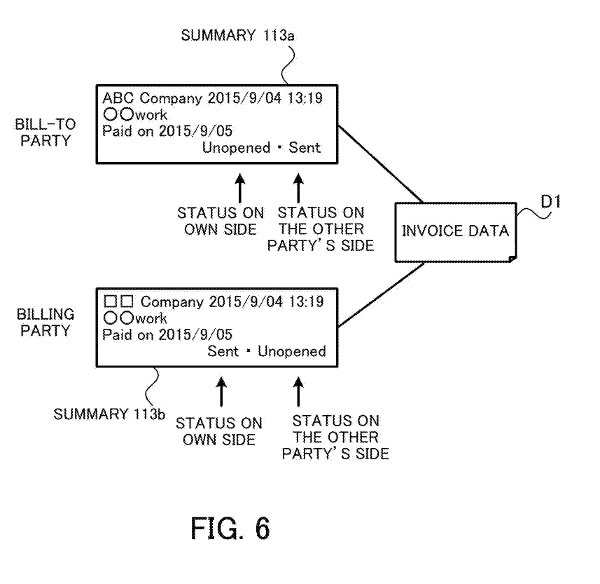

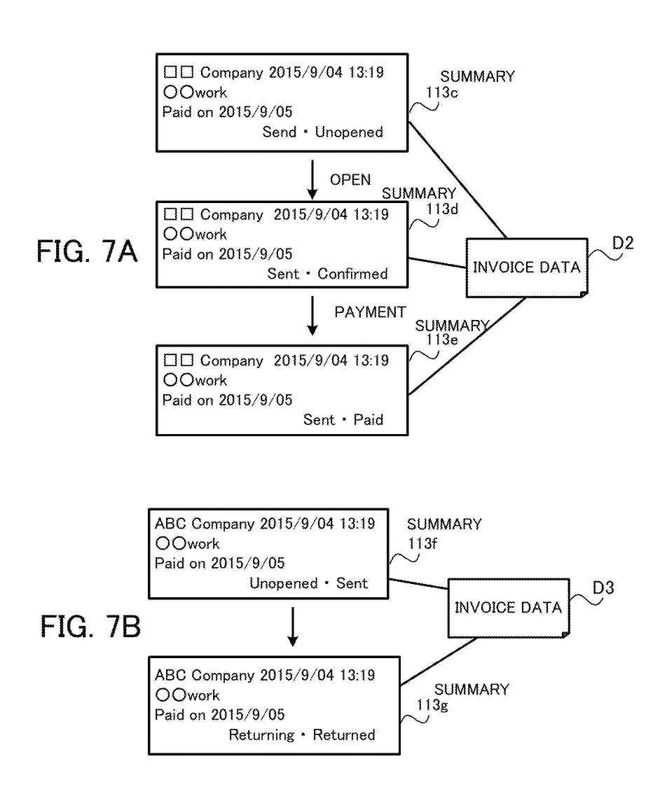

FIGS. 6 and 7 are views for explaining information to be displayed in the summary display area.

FIG. 6 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the billing party.

More specifically, invoice data D1 with a billing party of ABC company and a case name of OO work, as illustrated in FIG. 6, is in the “Sent” status in the status display area on the management screen of the terminal device operated by the accounting personnel of the billing party. When the accounting personnel of the billing party has selected the “Sent” status in the status display area, the following information is displayed with respect to the invoice data D1 in the summary display area 113: a bill-to party is □□ company, a case name is OO work, a status on the accounting personnel's side of the billing party is “Sent,” and a status on the accounting personnel's side of the bill-to party is “Unopened.”

By confirming status transitions, the accounting personnel of the billing party is able to easily confirm the progress of processing made by the accounting personnel of the bill-to party. That is to say, the accounting persons of both parties are able to confirm the current status of each invoice data in real-time.

All summaries 113c, 113d, and 113e illustrated in FIG. 7A are of invoice data D2.

When the accounting personnel of the bill-to party has viewed the invoice data D2 and selected a Confirm button (will be described later), the data processing unit 11 changes information displayed in the summary display area 113 from the summary 113c to the summary 113d on the management screen 110 of the terminal device operated by the accounting personnel of the billing party.

After that, when the accounting personnel of the bill-to party has made payment for the invoice data D2 and selected a Paid button (will be described later), the data processing unit 11 changes information displayed in the summary display area 113 from the summary 113d to the summary 113e on the management screen 110 of the terminal device operated by the accounting personnel of the billing party.

As another example, both summaries 113f and 113g illustrated in FIG. 7B are of invoice data D3.

When the accounting personnel of the bill-to party has viewed the invoice data D3 and selected a Return button (will be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the invoice data in common format in the invoice display area 114. More specifically, the data processing unit 11 refers to the invoice data management table T1. Then, the data processing unit 11 extracts the invoice data of the corresponding record and places its contents in the appropriate items in the invoice display area 14.

Sealing is omitted in the invoice displayed in the invoice display area 114. No inconvenience occurs even in the case where sealing is omitted because original invoices are digitized and processed electronically, as described earlier. In this connection, the contents (items) of the invoice data displayed in the invoice display area 114 are the same as those of existing (paper-based or PDF-based) invoices, except that an address display area 114a and various buttons, which will be described later, are displayed.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel has selected the Confirm button 114b, the data processing unit 11 refers to the invoice data management table T1. The data processing unit 11 then changes the Status on Personnel's Side column to “confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel has selected the Return button 114c, the data processing unit 11 refers to the invoice data management table T1. The data processing unit 11 then changes the Status on Personnel's Side column to “returning” with respect to the invoice data being displayed in the invoice display area 114, and then changes the Status on the Other Party's Side column to “returned”. In addition, the data processing unit 11 decreases the number for the “Unopened” status by one and increases the number for the “Returning” status by one in the status display area 112.

On the management screen of the accounting personnel who has received the returned invoice data, the number for the “Sent” status is decreased by one and the number for the “Returned” status is increased by one in the status display area 112.

When the accounting personnel has selected the Copy button 114d, the data processing unit 11 creates new invoice data by replacing the company name and address between the billing party and the bill-to party in the invoice data. Then, the data processing unit 11 stores information on the created invoice data in the invoice data management table T1. At this time, with respect to the invoice data, “Draft” is set in the Status on Personnel's Side column and a blank is set in the Status on the Other Party's Side column.

(Returns Processing)

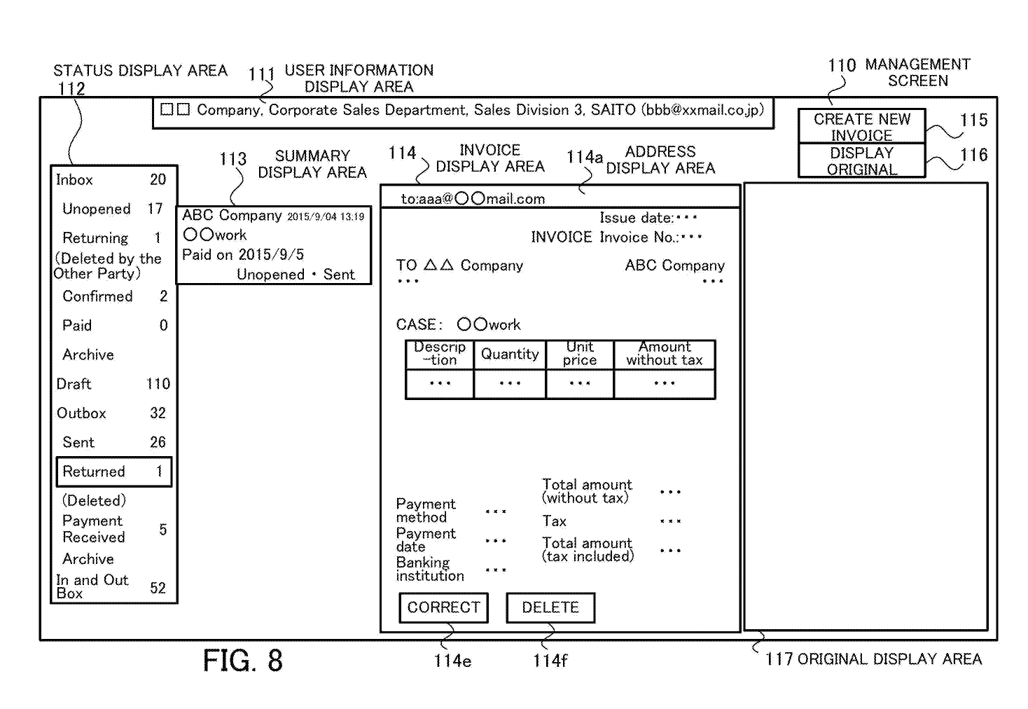

FIG. 8 is a view for explaining how to process returned invoice data.

When the accounting personnel has selected the Returned status and then selected the summary of an invoice being displayed in the summary display area 113, the data processing unit 11 displays invoice data corresponding to the selected summary of the invoice in the invoice display area 114. In this case, the mail address of the accounting personnel of the bill-to party is displayed in the address display area 114a.

The invoice display area 114 includes a Correct button 114e and a Delete button 114f.

When the accounting personnel has selected the Correct button 114e, the data processing unit 11 changes the status of the invoice data being displayed in the invoice display area 114 to “Deleted”. In addition, the data processing unit 11 decreases the number for the “Returned” status by one in the status display area 112. In addition, this information is added as a history.

When the accounting personnel has selected the Delete button 114f, the data processing unit 11 changes the status of the invoice data being displayed in the invoice display area 114 to “Deleted”. Thereby, the numbers for the “Outbox” folder and “Returned” status are each decreased by one in the status display area 112.

In this connection, the accounting personnel of the billing party and the accounting personnel of the bill-to party are able to view invoice data even after the invoice data is deleted.

More specifically, by selecting the “Deleted” status in the status display area 112, the accounting personnel of the billing party is able to view deleted invoice data. On the other hand, by selecting the “Deleted by the Other Party” status in the status display area 112, the accounting personnel of the bill-to party is able to view deleted invoice data.

Refer now back to FIG. 2.

Among all invoice data placed in the Inbox and Outbox folders, data other than deleted invoice data, invoice data saved in the archive, and invoice data in the Draft status is placed in the In and Out Box folder.

The following describes a flow of processing. In the following description, it is assumed that an accounting personnel of a billing party is Saito of □□ company and an accounting personnel of a bill-to party is Suzuki of ABC company.

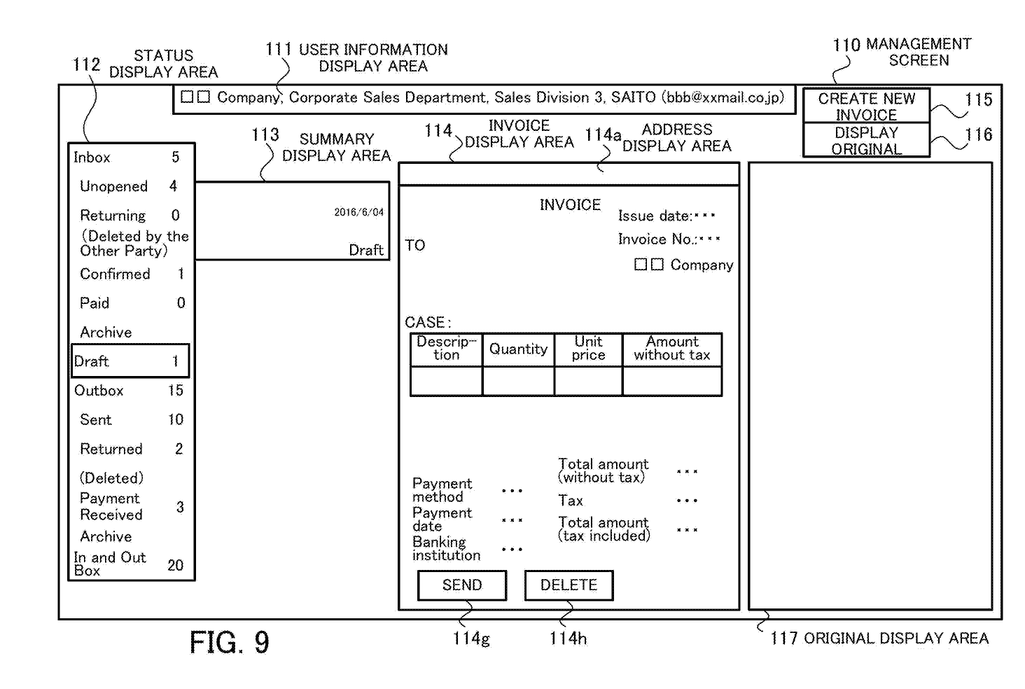

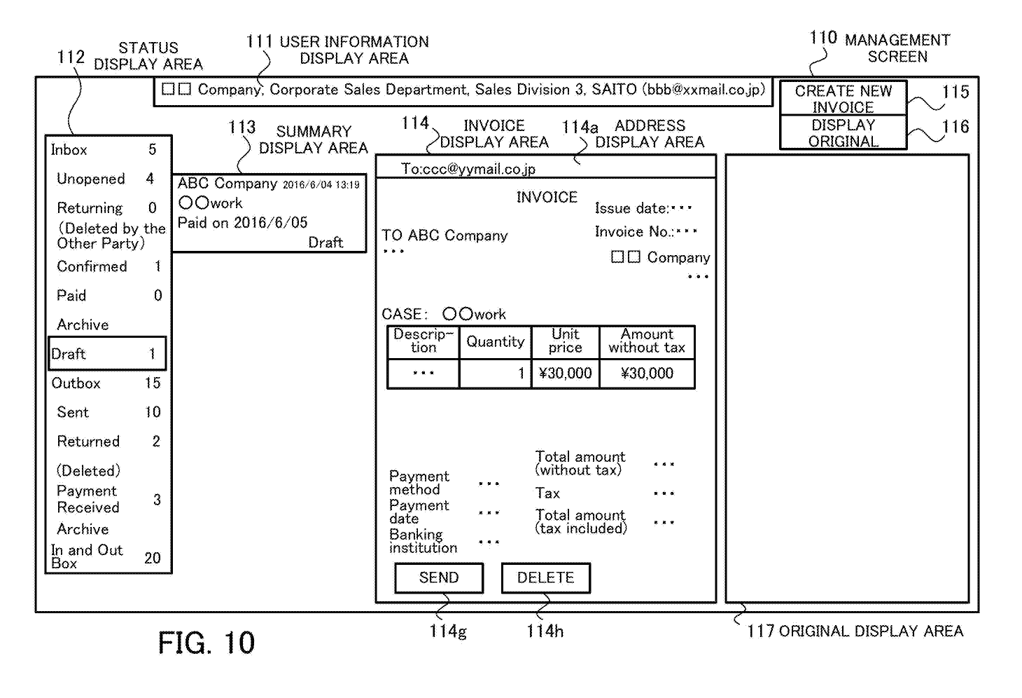

FIGS. 9 and 10 are views for explaining the management screen to be displayed at the time of creation of a new invoice.

The management screen 110 in FIG. 9 is a screen to be displayed on a terminal device operated by the accounting personnel of the billing party.

When the accounting personnel of the billing party has selected a Create New Invoice button 115, the data processing unit 11 creates invoice data, which is given the “Draft” status. Then, the data processing unit 11 accesses the format storage unit 13 and displays the invoice data in common format in the invoice display area 114. At this time, each item is blank.

In this connection, to create a new invoice based on an already created invoice, the accounting personnel displays desired invoice data placed in the Outbox folder in the invoice display area 114 and selects the Copy button 114d. Thereby, the data processing unit 11 displays invoice data including partial information, such as payment method, payment date, and financial institution, in the invoice display area 114.

The invoice display area 114 has a Send button 114g and a Delete button 114h.

As illustrated in FIG. 10, when the accounting personnel of the billing party has filled in the items displayed in the invoice display area 114 and selected the Send button 11g, the data processing unit 11 stores the invoice data with the filled items in the invoice data management table T1. In addition, the data processing unit 11 refers to the format storage unit 13 and creates a pdf file of the invoice data with the filled items using the original format associated with the mail address of the accounting personnel of the billing party. Then, the data processing unit 11 stores the created pdf file in the pdf data storage unit 14.

When the accounting personnel of the billing party has selected the Delete button 114h, the data processing unit 11 deletes the drafted contents.

In addition, when the accounting personnel of the billing party has selected the Display Original button 116 while invoice data is displayed in the invoice display area 114, the data processing unit 11 retrieves the pdf file in original format corresponding to the invoice data displayed in the invoice display area 114, from the pdf data storage unit 14 and displays the pdf file in the original display area 117.

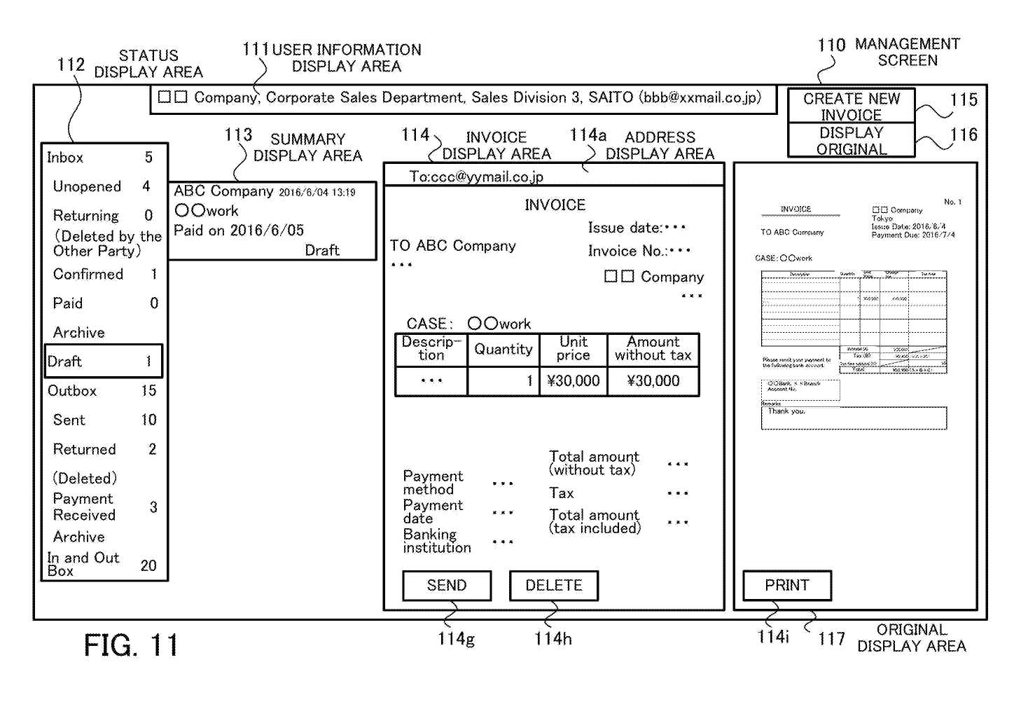

FIG. 11 illustrates an invoice to be displayed in the original display area.

The original display area 117 has a Print button 114i. When the accounting personnel of the billing party has selected the Print button 114i, the data processing unit 11 displays a print screen (not illustrated) for printing the invoice data displayed in the original display area 117, on the monitor.

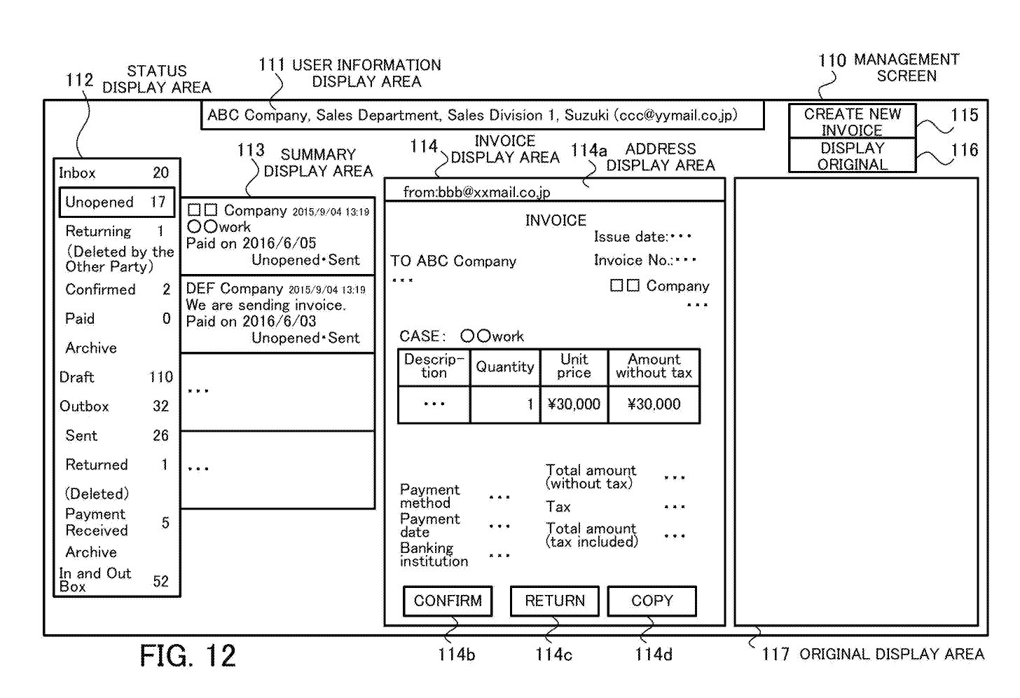

FIG. 12 illustrates a management screen to be displayed on the terminal device operated by the accounting personnel of the bill-to party.

When the accounting personnel of the bill-to party has selected the summary of invoice data displayed in the summary display area 113, the data processing unit 11 displays the invoice data in common format in the invoice display area 114. In addition, when the accounting personnel of the bill-to party has selected the Display Original button 116 while the invoice data is displayed in the invoice display area 114, the data processing unit 11 retrieves the pdf file in original format corresponding to the invoice data displayed in the invoice display area 114, from the pdf data storage unit 14 and displays the pdf file in the original display area 117.

As described above, the invoice management system 10 is designed such that invoice data in common format is displayed in the invoice display area 114, and the invoice data in original format is displayed in the original display area 117. This makes it possible simplify the processing performed by the invoice management apparatus 1, as compared with the case of displaying an original format unique to a company in the invoice display area 114.

In addition, the original display area 117 is provided on the management screen 110, such as to display invoice data in original format in the original display area 117. Thereby, it is possible to display two invoices on one screen. This eliminates the need of screen switching.

In this connection, if there are too many contents to display in the invoice display area 114 on one screen, the details of the invoice in the invoice display area 114 may be scrolled to display the hidden contents. At this time, the original display area 117 may be scrolled according to the displayed portion of the invoice in the invoice display area 114, so as to thereby display the corresponding displayed portion of the pdf file in the original display area 117.

In this connection, in the present embodiment, the original display area 117 is a dedicated space for displaying invoice data in original format. However, the original display area 117 may be used as a common space for displaying other information.

In addition, in the embodiment, when the accounting personnel of the billing party has selected the Send button 114g, the data processing unit 11 creates a pdf file of the invoice data with filled items. Timing of creating the pdf file is not limited thereto and, for example, the pdf file may be created when the Display Original button 116 is selected.

As described earlier, invoice data is not communicated directly between the terminal devices 2a, 2b, and 2c. The invoice data created using the terminal devices 2a, 2b, and 2c and sent to bill-to parties is held by the invoice management apparatus 1 and is treated like shared data. Therefore, the accounting personnel of a bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

Information on invoice data is stored in the invoice data management table T1 when the invoice data is sent, and the statuses of subsequent transactions are managed using this invoice data management table T1. Therefore, accounting persons are able to get away from manually compiling invoices into a data sheet.

In this connection, processes performed by the invoice management apparatus 1 may be performed by a plurality of apparatuses in a distributed manner.

In addition, in the embodiment, the invoice management apparatus 1 has various storage units including the invoice data storage unit 12. Alternatively, each storage unit may be provided at a different location from the data processing unit 11 in cloud-based platform.

Heretofore, the information processing apparatus and display method have been described as the embodiment illustrated. The embodiment is not limited thereto, and the components of each unit may be replaced with other components having equivalent functions or other components. In addition, other desired configurations and steps may be added to the embodiment.

The above-described processing functions may be implemented by using a computer. In this case, a program is prepared, which describes processes for the functions of the invoice management apparatus 1. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, Flexible Disks (FD), Magnetic Tapes, etc. The optical discs include DVDs, DVD-RAMs, CD-ROMs, CD-RWs, etc. The magneto-optical recording media include MOs (Magneto-Optical disk), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer over a network, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible both to simplify a system configuration and to allow for customization.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a storage unit configured to store therein, upon receipt of document data relating to a business document sent from a terminal device to a specific recipient over a network, the received document data in association with identification information of the recipient and identification information of an issuer of the document data;
a storage unit configured to store therein a first format in which display items are fixed and a second format in which the display items are changeable according to a user request;
a processing unit configured to create, based on first document data created using the first format by the issuer, second document data using the second format, the second document data having identical contents to the first document data and having desired display items; and
a display unit configured to display the first document data created using the first format and the second document data created using the second format in response to a request for displaying the document data from the recipient.

2. The information processing apparatus according to claim 1, wherein the display unit displays the first document data in the first format and the second document data in the second format on a same screen.

3. The information processing apparatus according to claim 1, wherein the second document data displayed in the second format is scrolled along with scroll of the first document data displayed in the first format within the screen.

4. A display method executed by a computer including a storage unit configured to store therein, upon receipt of document data relating to a business document sent from a terminal device to a specific recipient over a network, the received document data in association with identification information of the recipient and identification information of an issuer of the document data and a storage unit configured to store therein a first format in which display items are fixed and a second format in which the display items are changeable according to a user request, the display method comprising:
creating, based on first document data created using the first format by the issuer, second document data using the second format, the second document data having identical contents to the first document data and having desired display items; and
displaying the first document data created using the first format and the second document data created using the second format in response to a request for displaying the document data from the recipient.

5. A non-transitory computer-readable recording medium storing a computer program executed by a computer including a storage unit configured to store therein, upon receipt of document data relating to a business document sent from a terminal device to a specific recipient over a network, the received document data in association with identification information of the recipient and identification information of an issuer of the document data and a storage unit configured to store therein a first format in which display items are fixed and a second format in which the display items are changeable according to a user request, the computer program causing the computer to perform a process comprising:
creating, based on first document data created using the first format by the issuer, second document data using the second format, the second document data having identical contents to the first document data and having desired display items; and
displaying the first document data created using the first format and the second document data created using the second format in response to a request for displaying the document data from the recipient.
